(19) United States
(12) Patent Application Publication
(10) Pub. No.: US 2018/0178578 A1
(43) Pub. Date: Jun. 28, 2018

(54) OPTICAL DEVICE HAVING A HIDDEN DEPICTION

(71) Applicant: CCL Secure Pty Ltd, Craigieburn, Victoria (AU)

(72) Inventor: Chris Tierney, Craigieburn, Victoria (AU)

(73) Assignee: CCL Secure Pty Ltd, Craigieburn, Victoria (AU)

(21) Appl. No.: 15/580,974

(22) PCT Filed: Jun. 10, 2016
(86) PCT No.: PCT/AU2016/050469

§ 371 Date: Dec. 8, 2017

(30) Foreign Application Priority Data
Jun. 10, 2015 (AU) 2015100789
Jun. 10, 2015 (AU) 2015902188

(51) Int. Cl. B42D 25/351; B42D 25/333; B42D 25/378; B42D 25/435; B42D 25/29; B41M 3/14

(52) U.S. Cl. CPC B42D 25/351; B42D 25/333; B42D 25/378; B42D 25/23; B42D 25/29; B41M 3/14; B42D 25/435

(57) ABSTRACT

An optical device, preferably a security device for a security document, including: a transparent or translucent substrate having a first side and a second side; a first depiction layer located on the first side of the substrate defining a first depiction; and a first masking layer, comprising a first optically variable ink, and a second masking layer, comprising an optically variable ink, located at least partially overlapping the first depiction layer, wherein the first depiction is at least substantially opaque and has a low contrast with respect to the appearance of the first and second masking layers when viewed in reflection, such that the first depiction is identifiable and substantially more visible when viewed in transmission than when viewed in reflection, and method for the manufacture thereof.

### FIELD OF THE INVENTION

The invention relates to optical devices such as security devices, such as provided with security documents such as banknotes. In particular, the invention relates to the provision of a watermark visual effect in a region of a document, in particular a window region.

### BACKGROUND TO THE INVENTION

Optical devices are often utilised to attest to the authenticity of a document. Such optical devices, when utilised in this manner, are sometimes referred to as security devices, and documents incorporating the optical devices as security documents. The devices are required to prevent counterfeiting of security documents and in the case of overt security devices, should be easily and quickly identifiable on the document.

A watermark is a recognisable image or pattern that appears lighter or darker than the surrounding substrate when viewed in transmission. The name is derived from the method on creation of the images on paper. Watermarks have been used extensively in security printing and, in particular, bank notes for many years. As a result, they are widely recognised by the general public as a mark of authenticity. Watermarks are also present on polymer currency, for example, Australia has its coat of arms viewable in transmission on all its polymer notes. Whilst the watermark present in these polymer notes is not manufactured using the process that gave “watermarks” their name, they do provide the key elements that the general public recognise as a watermark, that is, an image is viewable in transmission which is, generally, not viewable in reflection.

A security document including a sheet like substrate having a transparent area or “window” formed from a portion of transparent plastics material has previously been proposed. The window formed in the security document is particularly suited for incorporating a security device such as an embossed image or an optically variable device, such as a diffraction grating or hologram.

### SUMMARY OF THE INVENTION

According to an aspect of the present invention, there is provided an optical device, preferably a security device for a security document, including: a transparent or translucent substrate having a first side and a second side; a first depiction layer located on a first side of the substrate defining a first depiction; and a first masking layer, comprising a first optically variable ink, located at least partially overlapping the first depiction layer, wherein the first depiction is at least substantially opaque and has a low contrast with respect to the appearance of the first masking layer when viewed in reflection, such that the first depiction is identifiable and substantially more visible when viewed in transmission than when viewed in reflection.

In an embodiment, the first masking layer is located on the first side of the substrate. In another embodiment, the first masking layer is located on the second side of the substrate. The first masking layer may completely overlap the first depiction layer.

Typically the first depiction is defined by a printed ink or is applied using laser etching or laser marking.

Optionally, the optical device includes a second depiction layer located on the first side or the second side and defining a second depiction, wherein the first masking layer at least partially overlaps the second depiction layer, wherein the second depiction is at least substantially opaque and has a high contrast with respect to the appearance of the first masking layer when viewed in reflection, such that the second depiction is substantially visible when viewed in both reflection and transmission. Here, the first depiction and the second depiction may complement one another. Preferably, the second depiction layer is located on the first side, and the first depiction layer is applied to the substrate before the second depiction layer. Alternatively, the second depiction layer may be located on the first side, and the second depiction layer may be applied to the substrate before the first depiction layer. Typically the second depiction is defined by a printed ink or is applied using laser etching or laser marking.

Optionally, the optical device includes a second masking layer comprising a second optically variable ink located on the first side or the second side at least partially overlapping the first depiction layer, wherein the first depiction layer is located between the first masking layer and the second masking layer, wherein the first depiction layer has a low contrast with respect to the appearance of the second masking layer when viewed in reflection, such that the first depiction is identifiable and substantially more visible when viewed in transmission than when viewed in reflection, when viewed through either the first or second masking layers. The first optically variable ink may be the same as the second optically variable ink, or in an alternative, the first optically variable ink may be different to the second optically variable ink. Preferably, the second masking layer completely overlaps the first depiction layer.

According to another aspect of the present invention, there is provided a method of manufacturing an optical device, comprising the steps of: applying an at least substantially opaque first depiction to a first side of a transparent or translucent substrate; and applying a first optically variable ink to either the first or a second side of the substrate such as to at least partially overlap the first depiction, wherein the first optically variable ink has a different appearance when viewed in transmission and reflection, and wherein the first depiction is selected to have a low contrast with respect to the appearance of the first optically variable ink in reflection, such that the first depiction is identifiable and substantially more visible in viewed in transmission when compared to the reflection.

Preferably, the first depiction is defined by an ink, and the step of applying the first depiction comprises a printing step such as: gravure, intaglio, silk screen, etc., or alternatively, the first depiction is applied using laser etching or laser marking.

Optionally, the method includes the step of applying a second depiction to either the first side or the second side of the substrate, wherein the second depiction is different in colour appearance to the first depiction, such that the second depiction is substantially visible when viewed in both reflection and transmission.

Optionally, the method includes the step of applying a second optically variable ink to either the first side or the second side of the substrate located such that the first depiction is located between the first masking layer and the second masking layer, the second optically variable ink selected such that the first depiction layer has a low contrast with respect to the appearance of the second optically variable ink when viewed in reflection, such that the first depiction is identifiable and substantially more visible when viewed in transmission than when viewed in reflection, when viewed through either the first or second optically variable inks.

According to yet another aspect of the present invention there is provided a document, preferably a security document such as a banknote, comprising the optical device of the first aspect or the optical device manufactured according to the second aspect discussed above. Typically, the optical device is located within a transparent window of the document.

Depictions and Images

The terms “depiction” and “image” are used herein to describe arrangements of ink on a surface of the optical device which may be viewed by a viewer (such as a typical human user). The terms are used in a synonymous sense, and should not be construed as signifying differences in concept.

Depictions and images can include the following: symbols; characters; numbers; portraits; codes; encrypted and/or scrambled visual information; patterns; geometric shapes; microimages; etc.

Visibility

The terms “visible” and “non-visible” are used herein to distinguish between different visual appearances of the optical device. It is understood that the terms are not to be construed absolutely, and rather, the terms are used herein in a relative sense. A visible “image” or “depiction” is one that is relatively easy for a viewer (such as a typical human user) to identify, whereas a non-visible “image” or “depiction” is one that is more difficult in comparison, or impossible, for a viewer (such as a typical human user) to identify. The ability to identify the depiction or image of the optical device may vary with ambient lighting conditions, for example a non-visible image may be impossible to identify in some lighting conditions, and merely more difficult to identify in other ambient lighting conditions.

Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein can also have application in other products, such as packaging.

Security Device or Feature

As used herein the term security device or feature includes any one of a large number of security devices, elements or features intended to protect the security document or token from counterfeiting, copying, and alteration or tampering. Security devices or features can be provided in or on the substrate of the security document or in or on one or more layers applied to the base substrate, and can take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### BRIEF DESCRIPTION OF THE DRAWINGS

In order that the present invention may be more readily understood, various embodiments thereof will now be described, by way of example only, with reference to the accompanying drawings, in which:

FIG. 1a shows a document having an optical device located in a half-window region of the document;

FIG. 1b shows a document having an optical device located in a window region of the document;

FIG. 2 shows the appearance of the optical device according to an embodiment;

FIG. 3 shows the different viewing conditions for viewing an optical device;

FIG. 4a shows a layer arrangement of an optical device according to an embodiment;

FIG. 4b shows the appearance of the optical device of FIG. 4a under different viewing conditions;

FIGS. 4c and 4d show alternative layer arrangements to that of FIG. 4a;

FIG. 5a shows a layer arrangement of an optical device according to an embodiment;

FIG. 5b shows the appearance of the optical device of FIG. 5a under different viewing conditions;

FIG. 6a shows a layer arrangement of an optical device according to an embodiment;

FIG. 6b shows the appearance of the optical device of FIG. 6a under different viewing conditions; and

FIG. 6c shows an alternative layer arrangement to that of FIG. 6a.

### DESCRIPTION OF PREFERRED EMBODIMENT

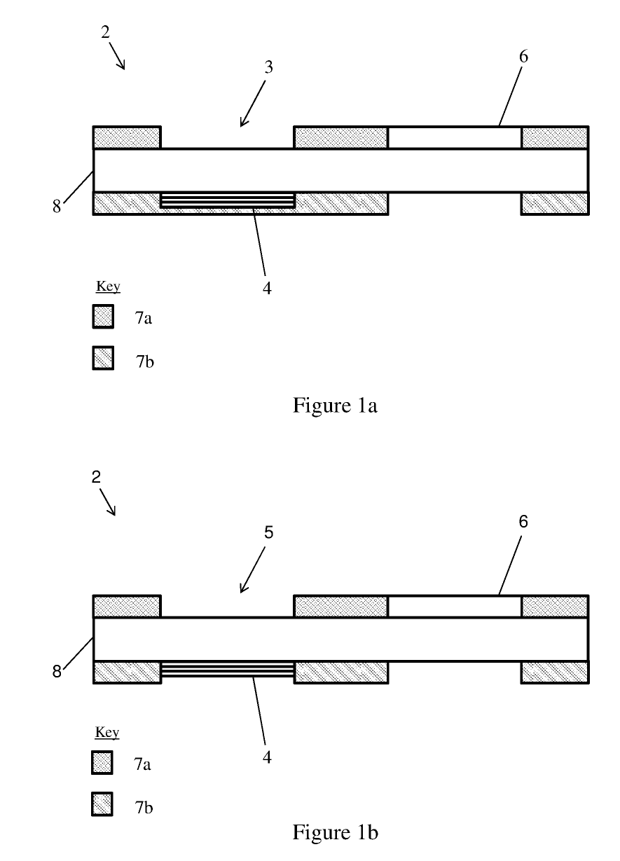

For the purpose of the disclosure herein, a general feature referred to in the figures is labelled with a number. Where it is necessary to distinguish specific instances of the general feature, the specific instance is labelled with the number of the general feature and a unique letter suffix. Reference can be made to the general feature by omitting the suffix and one or more specific instances by including the suffix. For example, FIGS. 1a and 1b show opacifying layers 7, specifically first opacifying layer 7a and second opacifying layer 7b. Dotted lines in the figures represent boundaries not necessarily visible or identifiable to a user viewing the optical device.

FIGS. 1a and 1b show a document 2, in this case and herein referred to as a security document 2 (such as a banknote), including an optical device 4 and an optional further security feature 6. The security document 2 includes a substrate 8.

In the embodiments described with reference to the figures, the optical device 4 is formed directly onto the substrate 8 of the security document 2. However, it is envisaged that in other embodiments the optical device 4 is formed on one or more separate substrates, and subsequently applied to the substrate 8 of the security document 2 through well-known procedures such as hot-stamping. Generally, the purpose of the optical device 4 is to provide a security feature for the security document 2, such that the optical device 4 acts as a ‘security device’ for providing means for determining the authenticity of the security document 2. It is understood however that the optical device 4 can provide non-security functionality (either wholly or in combination with the security function), such as a decorative function.

The embodiments herein described also include first and second opacifying layers 7a, 7b applied to the substrate 8. In both FIGS. 1a and 1b, the first opacifying layer 7a is not applied in an area corresponding to the optical device 4. In the embodiment of FIG. 1a, the optical device 4 is shown located in a half-window region 3 of the security document 2, which is the result of the second opacifying layer 7b covering the optical device 4. FIG. 1b shows an alternative embodiment, wherein the optical device 4 is located in a window region 5 of the security document 2, wherein the second opacifying layer 7b is also not applied in an area corresponding to the optical device 4. Although the opacifying layers 7a, 7b are shown contiguous with the optical device 4, this is not necessary. For example, there may be a gap between the edge of the optical device 4 and the edge of one or both of the opacifying regions 7a, 7b. Furthermore, it is envisaged that one or both of the opacifying layers 7a, 7b may be excluded, or may be replaced with transparent (that is, non-opacifying) layers.

It is envisaged that at least one of the opacifying layers 7a, 7b could partially cover the optical device 4. In one embodiment, one of the opacifying layers (for sake of example, the second opacifying layer 7b) partially covers the optical device 4 whereas the other of the opacifying layers (according to the example, the first opacifying layer 7a) is completely absent in the area of the optical device 4. In this way, the optical device 4 is partially located in a window 5 of the security document 2, and partially located in a half-window 3 of the security document 2.

Optional further security features 6 include diffractive optical devices, holograms, microlens based optical variable devices, windows, and any other suitable security feature(s), and can be located within window or half-window regions of the substrate 8 as necessary and/or desired. The optional security feature(s) 6 can be located in windows, half-windows, or on an opacifying layer 7a, 7b. Furthermore, one or more optional security features 6 can be located in the same window or half-window region as the optical device 4.

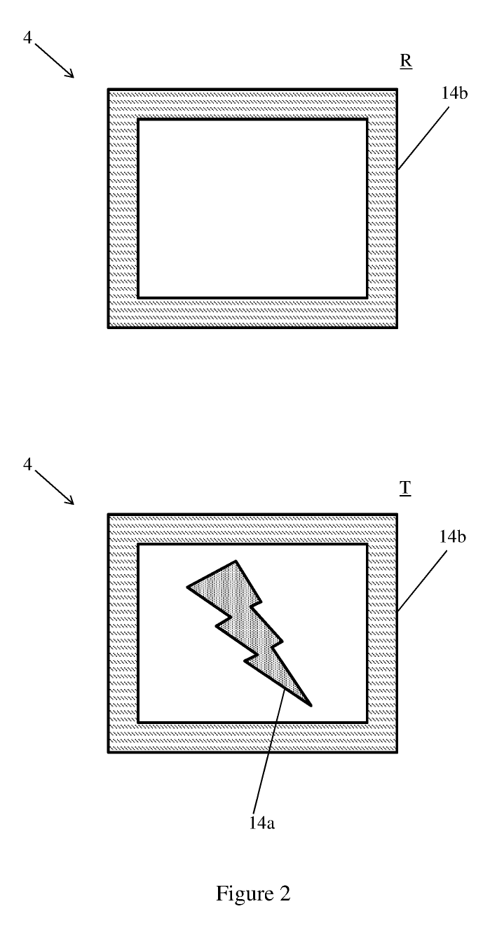

Referring now to FIG. 2, in general, the appearance of the optical device 4 when viewed in reflection (R) is different to the appearance of the optical device 4 when viewed in transmission (T). As shown, typically, a first depiction 14a is visible when the optical device 4 is viewed in transmission (T), which is not visible when the optical device 4 is viewed in reflection (R). This first depiction 14a typically has an associated colour. FIG. 2 also shows an optional second depiction 14b. The second depiction 14b is visible in reflection and transmission.

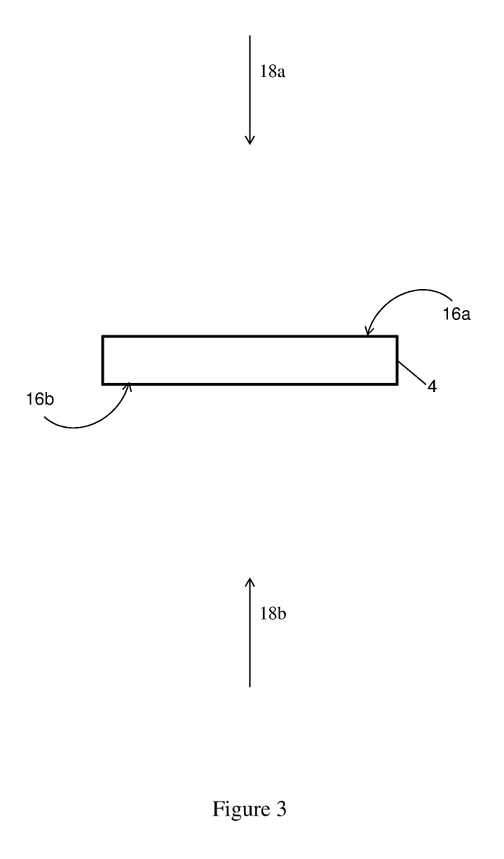

Referring to FIG. 3, the optical device 4 includes a first side 16a and a second side 16b, each associated with a viewing direction 18a, 18b. The first viewing direction 18a corresponds to a user viewing the first side 16a directly, and the second viewing direction 18b corresponds to the user viewing the second side 16b directly. Furthermore, a user viewing the optical device 4 can view the device in reflection (R) or transmission (T), from one of the viewing directions 18a, 18b. In general, reflection (R) corresponds to a light source being positioned to illuminate the same side 16a, 16b of the optical device 4 as that being viewed by the user, whereas transmission (T) corresponds to a light source being position to illuminate the opposite side 16a, 16b of the optical device 4 as that being viewed by the user.

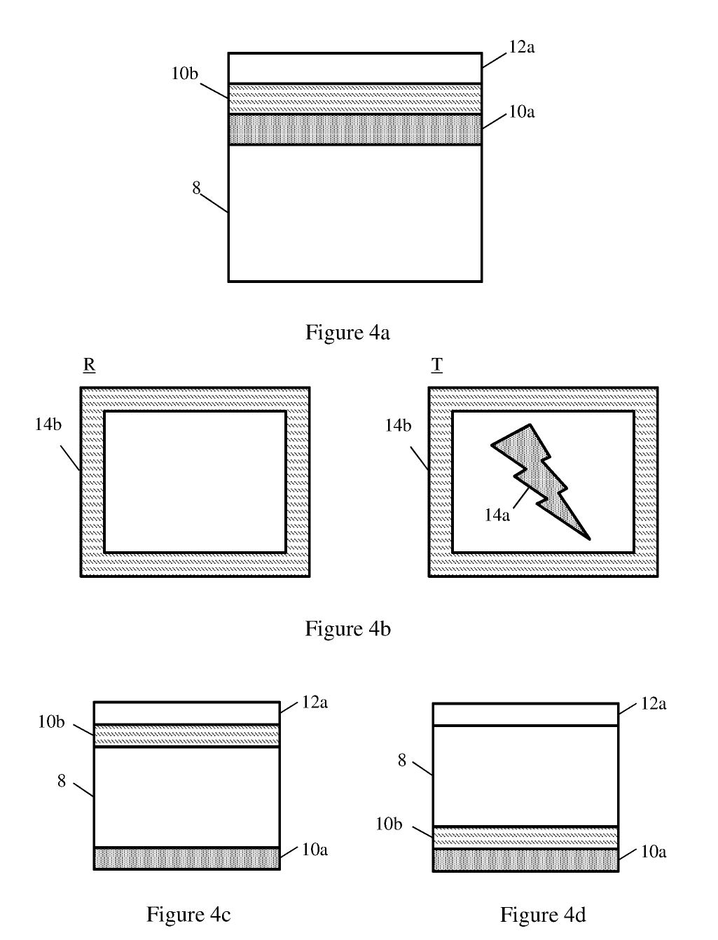

Referring to FIGS. 4a, 5a, and 6a, the optical device includes a first masking layer 12a, which comprises an optically variable ink. In one embodiment the optically variable ink is a colour shifting ink as described in WO2006/133512. Such a colour shifting ink, typically, includes a composition with a major proportion of an optically variable pearlescent interference pigment and a minor proportion of a transparent organic pigment. The interference pigment and particles of the transparent organic pigment may be mixed with a transparent binder or resin to form the colour shifting ink composition which is suitable for application to a substrate in a printing process.

The colour shifting ink is preferably formed from a formulation including from about 10% to about 30% of a pearl lustre interference pigment (for example, interference pigments produced by the Kunwei Pearl Pigment Co. Ltd), from about 0.5% to about 10% of an organic pigment, e.g. phthalocyanine blue, and from about 60% to 90% of transparent binder or resin. Preferably, the pearl lustre interference pigments have a particle size from about 5 μm (microns) to about 200 μm (microns).

The masking layer 12 changes in colour due to changes in viewing angle while maintaining observation in reflection. This is not considered a problem or disadvantage with the masking layer 12, and in fact provides further functionality, for example, by providing further deterrence to counterfeiting of the security document 2.

Referring to FIGS. 4a, an embodiment of the optical device 4 includes first and second depiction layers 10a, 10b and a first masking layer 12a, applied to the substrate 8. FIG. 4b shows the appearance of the optical device 4 when viewed in reflection (R) and transmission (T). The first depiction layer 12a defines the first depiction 14a and the second depiction layer 10b defines the second depiction 14b.

In general, both the first depiction layer 10a and the second depiction layer 10b correspond to printed inks applied to the substrate 8. The relative arrangement of the first and second depiction layers 10a, 10b may correspond to the order in which the layers were applied. However, as the first and second depictions 14a, 14b are defined by areas present and absent ink, it can be the case that the first and second depiction layers 10a, 10b correspond to interspersed regions of inks. Other techniques for providing depictions 14 may also be employed, for example laser marking or laser etching. The masking layer 12a overlaps, at least in part, each of the first and second depictions 14a, 14b.

Referring to FIG. 4b, the first depiction 14a is opaque, or at least substantially opaque. Furthermore, the first depiction 14a is selected such as to have a low contrast with the first masking layer 12a when viewed in reflection (R). The first depiction 14a is therefore difficult to identify when the optical device 4 is visually inspected in a reflection (R) and is therefore not visible. In addition, where the optically variable ink of the masking layer 12 includes interference pigments, at a particular viewing angle the interference pigment is viewable, which provides additional contrast and, in some embodiments, two different modes in reflection. The first mode being when the interference pigment is not viewable and the first depiction 14a is viewable at low contrast and the second mode being when the interference pigment is viewable and the first depiction 14a is viewable only at an even lower contrast or not at all. However, as the first depiction 14a is opaque, when viewed in transmission (T) the first depiction 14a is visible by virtue of it acting to block light from transmitting from one side of the optical device 4 to the other. This is in contrast to the first masking layer 12a, which is at least relatively transparent when viewed in transmission (T). In an embodiment, the first depiction 14a is coloured white.

The second depiction 14b is selected such that it is sufficiently contrasting with the appearance of the first masking layer 12a when viewed in reflection (R). This may be achieved, for example, by selecting a colour of the second depiction 14b which contrasts with the colour of the masking layer 12a when viewed in reflection (R). In an embodiment, the second depiction 14b is coloured black. By selecting a second depiction 14b which contrasts with the masking layer 12a in reflection, the view of the first depiction 14a is further obfuscated in reflection. However, the first depiction 14a is still viewable in transmission. Preferably, the second depiction 14b is a line drawing, with no tonal variation. Furthermore, the second depiction 14b preferably occupies between 1% and 10% of the area in which the first depiction 14a is provided. Preferably, the widths of lines making up the line drawing of the second depiction 14b are between 250 microns and 1000 microns.

In modifications of the present embodiment, the first and second depiction layers 10a, 10b and the first masking layer 12a are located on opposing sides of the substrate 8. FIGS. 4c and 4d show two alternatives. FIG. 4c shows the first depiction layer 10a located on an opposite side of the substrate 8 to both the second depiction layer 10b and the first masking layer 12a. FIG. 4d shows both the first and second depiction layers 10a, 10b on the opposite side of the substrate to first masking layer 12a.

The first depiction 14a and second depiction 14b can complement one another, meaning that when viewed in combination (that is, in transmission) the first and second depictions 14a, 14b form an identifiable complete depiction.

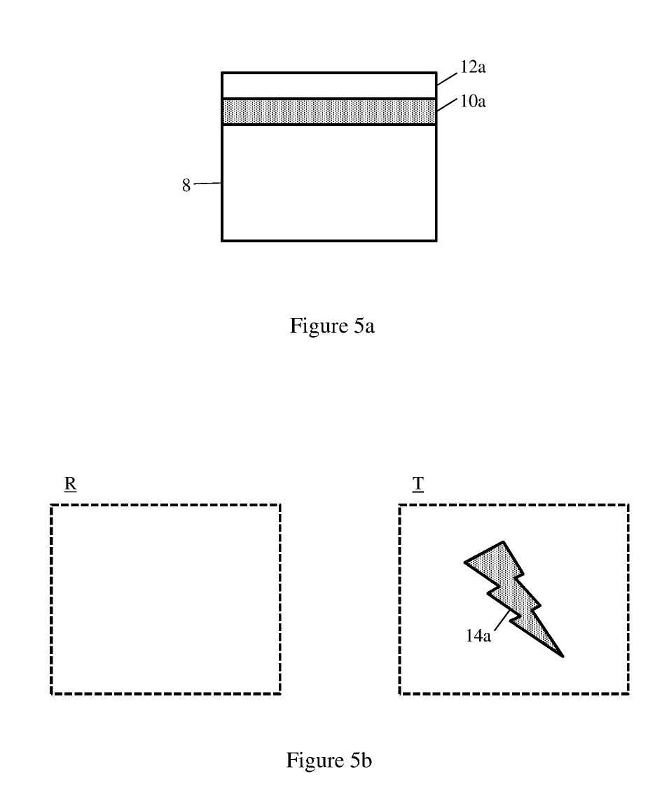

FIG. 5a shows another modification to the embodiment of FIG. 4a. Here, the second depiction layer 14b is not utilised, and therefore the optical device 4 comprises a first depiction layer 10a and a first masking layer 12a. The result is that there is no constant second depiction 14b as part of the overall optical effect, and only a first depiction 14a visible in transmission (T) and not reflection (R).

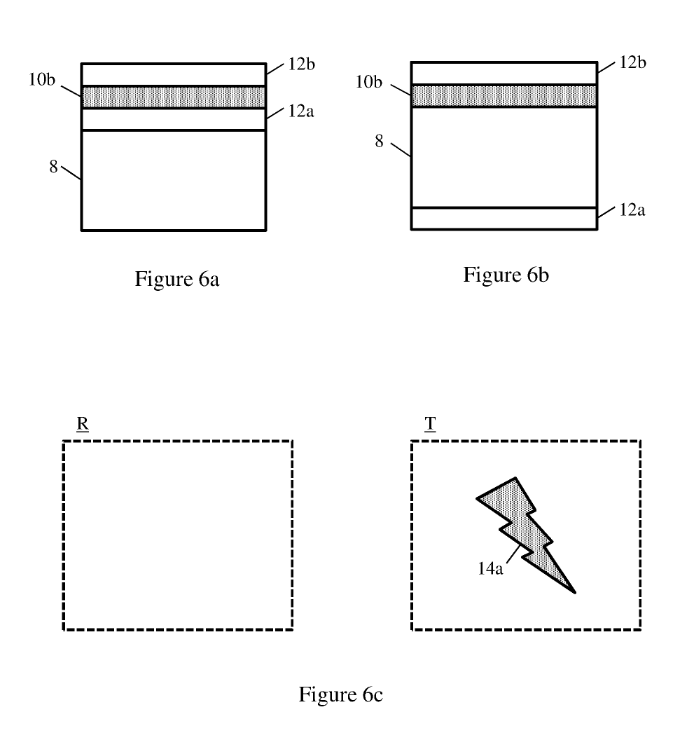

Referring to FIGS. 6a to 6c, another embodiment of the optical device 4 includes first and second masking layers 12a, 12b and a first depiction layer 10a located between the two masking layers 12a, 12b defining a first depiction 14a. As with the previously described embodiments, the first depiction 14a is visible in transmission and not visible in reflection.

FIGS. 6a and 6b show two implementations of the embodiment. FIG. 6a shows the first and second masking layers 12a, 12b and the first depiction layer 10a located on the same side of the substrate 8. FIG. 6b shows the first masking layer 12a located on an opposite side of the substrate 8 to the first depiction layer 10a and the second masking layer 12b.

Referring to FIG. 6c, similar to the other embodiments described herein, the first depiction 14a is opaque. The first depiction 14a is selected to be of low contrast to the appearance in reflection (R) of both the first and second masking layers 12a, 12b. The first and second masking layers 12a, 12b can comprise optically variable inks, and in this case can comprise either the same or different optically variable inks, depending on the desired appearance of the optical device 4.

Further modifications and improvements may be incorporated without departing from the scope of the invention. For example, the second ink layer 10b may comprise a plurality of different colours, each of which meets the contrast requirement of the second ink layer 10b a described herein. Furthermore, the masking layers 12 can comprise regions of different coloured optically variable inks providing a potentially more interesting visual effect.

1.-16. (canceled)

17. An optical device, preferably a security device for a security document, including:
a transparent or translucent substrate having a first side and a second side;
a first depiction layer located on the first side of the substrate defining a first depiction; and
a first masking layer, comprising a first optically variable ink, located at least partially overlapping the first depiction layer,
a second masking layer comprising a second optically variable ink located on the first side or the second side at least partially overlapping the first depiction layer wherein the first depiction layer is located between the first masking layer and the second masking layer is at least substantially opaque and has a low contrast with respect to the appearance of the first masking layer and the second masking layer when viewed in reflection,
such that the first depiction is identifiable and substantially more visible when viewed in transmission than when viewed in reflection, through either the first or second masking layers.

18. The optical device of claim 17, wherein the first depiction is defined by a printed ink or wherein the first depiction is applied using laser etching or laser marking.

19. The optical device of claim 17, including a second depiction layer located on the first side or the second side and defining a second depiction,
wherein the first masking layer at least partially overlaps the second depiction layer,
wherein the second depiction is at least substantially opaque and has a high contrast with respect to the appearance of the first masking layer when viewed in reflection,
such that the second depiction is substantially visible when viewed in both reflection and transmission.

20. The optical device of claim 19, wherein the first depiction and the second depiction complement one another.

21. The optical device of claim 19, wherein the second depiction layer is located on the first side, and wherein the first depiction layer is applied to the substrate before the second depiction layer.

22. The optical device of any claim 19, wherein the second depiction layer is located on the first side, and wherein the second depiction layer is applied to the substrate before the first depiction layer.

23. The optical device of any one of claim 19, wherein the second depiction is defined by a printed ink or wherein the second depiction is applied using laser etching or laser marking.

24. The optically variable device of claim 17, wherein the first masking layer completely overlaps the first depiction layer

25. The optical device of any one of claim 17, wherein the first optically variable ink is the same as the second optically variable ink.

26. The optical device of claim 17, wherein the first optically variable ink is different to the second optically variable ink.

27. The optically device of any one of claim 17, wherein the second masking layer completely overlaps the first depiction.

28. A method of manufacturing an optical device, comprising the steps of:
applying an at least substantially opaque first depiction to a first side of a transparent or translucent substrate; and
applying a first masking layer, comprising an optically variable ink, to either the first or a second side of the substrate such as to at least partially overlap the first depiction,
applying a second masking layer, comprising an optically variable ink, to either the first or the second side of the substrate such as to at least partially overlap the first depiction,
such that the first depiction layer is located between the first masking layer and the second masking layer
wherein the first masking layer has a different appearance when viewed in transmission and reflection, and wherein the first depiction is selected to have a low contrast with respect to the appearance of the first masking layer and second masking layer in reflection,
such that the first depiction is identifiable and substantially more visible in viewed in transmission when compared to the reflection.

29. The method of claim 29, wherein the first depiction is defined by an ink, and wherein the step of applying the first depiction comprises a printing step such as: gravure, intaglio, silk screen, etc., or wherein the first depiction is applied using laser etching or laser marking.

30. The method according to claim 29, further including the step of applying a second depiction to either the first side or the second side of the substrate,
wherein the second depiction is different in colour appearance to the first depiction, such that the second depiction is substantially visible when viewed in both reflection and transmission.

31. A document, preferably a security document such as a banknote, comprising the optical device of claim 17.

32. The document of claim 31, wherein the optical device is located with a transparent window of the document.

33. A document, preferably a security document such as a banknote, comprising the optical device manufactured by the method of claim 28.
